(19) United States
(12) Patent Application Publication
(10) Pub. No.: US 2025/0100410 A1
(43) Pub. Date: Mar. 27, 2025

(54) CHARGING SYSTEM, VEHICULAR CHARGING INLET, CHARGING DEVICE, AND CHARGING METHOD

(71) Applicant: TOYODA GOSEI CO., LTD., Kiyosu-shi (JP)

(72) Inventors: Kaho SATO, Kiyosu-shi (JP); Kenichiro KANEKO, Kiyosu-shi (JP)

(21) Appl. No.: 18/788,631

(22) Filed: Jul. 30, 2024

(30) Foreign Application Priority Data
Sep. 27, 2023 (JP) 2023-166422

(51) Int. Cl. B60L 53/37; B60L 53/16

(52) U.S. Cl. CPC B60L 53/37; B60L 53/16

(57) ABSTRACT

This charging system includes: a vehicular charging inlet provided to a vehicle and having a connection port exposable to vehicle-body outside; and a charging device provided outside the vehicle and including a charging gun having a connector portion to be inserted into the connection port at a time of charging the vehicle, and a movement mechanism unit for moving a position of the charging gun. The vehicular charging inlet has a marker exposed to vehicle-body outside and serving as a reference in positioning of the charging gun relative to the connection port before insertion of the charging gun into the connection port. The charging device includes an infrared camera for capturing an image of an area including the marker. The movement mechanism unit moves the position of the charging gun toward the connection port in accordance with a position of the marker in the image captured by the infrared camera.

### TECHNICAL FIELD

The present disclosure relates to a charging system, a vehicular charging inlet, a charging device, and a charging method that allow a vehicle to be charged by inserting a charging gun provided outside a vehicle into a connection port of a vehicular charging inlet provided to the vehicle.

### BACKGROUND ART

Conventionally, there has been known a charging system that allows a vehicle to be charged by inserting a charging gun provided to a charging device outside the vehicle into a connection port of a charging inlet provided to the vehicle (for example, Japanese Laid-Open Patent Publication No. 2020-162362; hereinafter, Patent Literature 1). In the charging system described in Patent Literature 1, the charging device includes a camera configured to capture an image of an area around the connection port of the charging inlet, and a movement mechanism unit such as an arm for moving the position of the charging gun. The position of the charging gun is moved by the movement mechanism unit toward the connection port whose position is specified through processing of the image captured by the camera, whereby the charging gun is inserted into the connection port.

### SUMMARY OF INVENTION

### Technical Problem

In such a configuration in which the position of the charging gun is moved toward the connection port on the basis of a camera image as in the charging system described in Patent Literature 1, detection accuracy for the position of the connection port through processing of an image captured by the camera is important. However, if the above camera is a general one for detecting visible-light wavelengths, a camera image is readily influenced by sunlight. Therefore, underexposure occurs in a dark place or overexposure (so-called blown-out highlights) occurs due to direct sunlight or the like, so that detection for the connection port becomes difficult, leading to reduction in positioning accuracy for the charging gun to the connection port.

The present disclosure has been made in view of the above circumstances, and an object of the present disclosure is to provide a charging system, a vehicular charging inlet, a charging device, and a charging method that stably ensure positioning accuracy for a charging gun to a connection port.

### Solution to Problem

One aspect of the present disclosure is directed to a charging system including: a vehicular charging inlet provided to a vehicle and having a connection port exposable to outside of a vehicle body; and a charging device provided outside the vehicle and including a charging gun having a connector portion to be inserted into the connection port at a time of charging the vehicle, and a movement mechanism unit configured to move a position of the charging gun. The vehicular charging inlet has a marker provided so as to be exposed to outside of the vehicle body and serving as a reference in performing positioning of the charging gun relative to the connection port before insertion of the charging gun into the connection port. The charging device includes an infrared camera configured to capture an image of an area including the marker. The movement mechanism unit moves the position of the charging gun toward the connection port in accordance with a position of the marker in the image captured by the infrared camera.

Another aspect of the present disclosure is directed to a vehicular charging inlet including: a connection port which is exposable to outside of a vehicle body and into which a charging gun of a charging device provided outside a vehicle is inserted at a time of charging the vehicle; and a marker which is provided so as to be exposed to outside of the vehicle body and whose image is to be captured by an infrared camera attached to the charging gun before insertion of the charging gun into the connection port, the marker serving as a reference in performing positioning of the charging gun relative to the connection port, for position movement of the charging gun by a movement mechanism unit of the charging device.

Another aspect of the present disclosure is directed to a charging device including: a charging gun to be inserted into a connection port of a vehicular charging inlet provided to a vehicle, at a time of charging the vehicle; an infrared camera configured to capture an image including a marker which is provided to the vehicular charging inlet so as to be exposed to outside of a vehicle body; and a movement mechanism unit configured to move a position of the charging gun toward the connection port in accordance with a position of the marker in the image captured by the infrared camera.

Another aspect of the present disclosure is directed to a charging method for charging a vehicle by inserting a charging gun of a charging device provided outside the vehicle into a connection port of a vehicular charging inlet provided to the vehicle, the charging method including: a first step of, by an infrared camera of the charging device, capturing an image of an area including a marker which is provided to the vehicular charging inlet so as to be exposed to outside of a vehicle body; and a second step of, by a movement mechanism unit of the charging device, moving a position of the charging gun toward the connection port in accordance with a position of the marker in the image captured by the infrared camera.

With the above configurations, positioning accuracy for the charging gun to the connection port is stably ensured.

### BRIEF DESCRIPTION OF DRAWINGS

FIG. 1 shows a configuration of a charging system according to an embodiment of the present disclosure.

FIG. 2 shows a configuration of a charging device included in the charging system according to the embodiment.

FIG. 3 is a front view of a vehicular charging inlet included in the charging system according to the embodiment.

FIG. 4 is a flowchart showing an example of a control routine executed by the charging system according to the embodiment.

### DESCRIPTION OF EMBODIMENTS

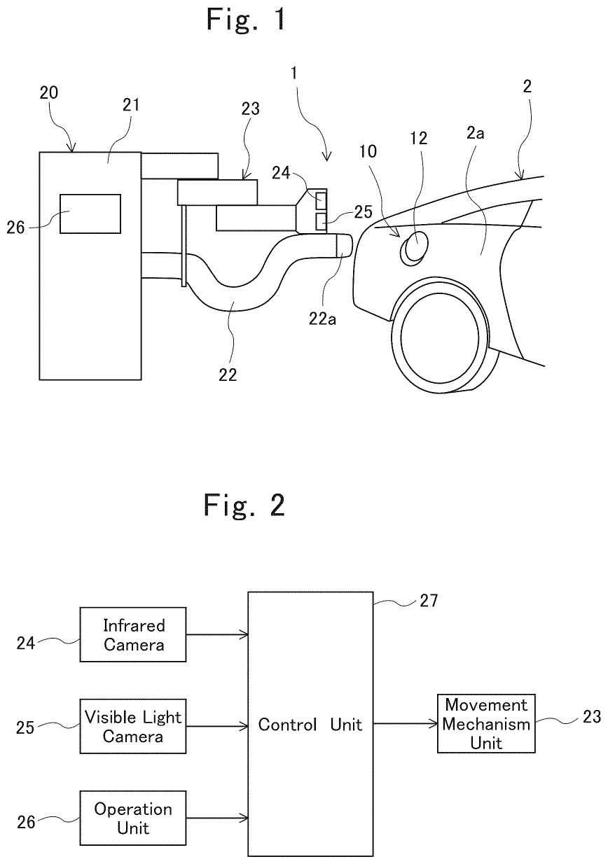

Hereinafter, with reference to FIG. 1 to FIG. 4, a specific embodiment of a charging system, a vehicular charging inlet, a charging device, and a charging method according to the present disclosure will be described.

A charging system 1 according to an embodiment is a system for charging a vehicle by inserting a charging gun of a charging device outside a vehicle into a connection port of a charging inlet of the vehicle. The vehicle to be charged by the charging system 1 is any vehicle that travels using electricity as motive power, and may be an electric vehicle or a plug-in hybrid vehicle.

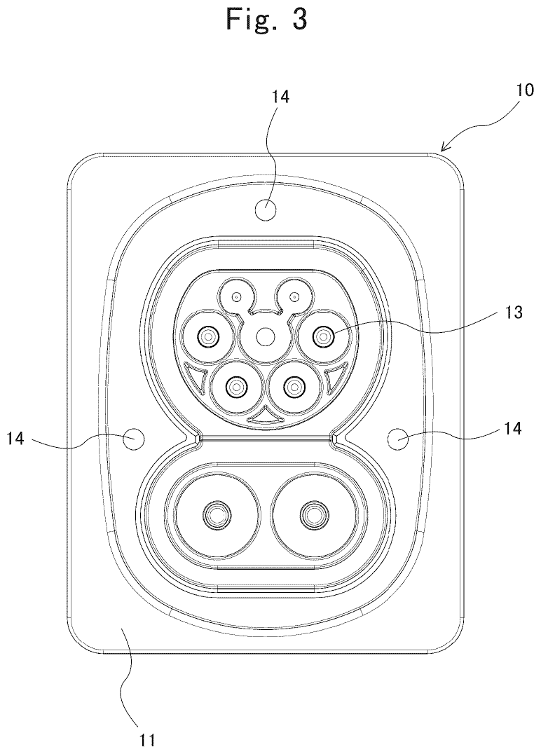

As shown in FIG. 1, FIG. 2, and FIG. 3, the charging system 1 includes a vehicular charging inlet 10 and a charging device 20.

The vehicular charging inlet 10 is a member modularized for charging the vehicle 2. The vehicular charging inlet 10 is provided to the vehicle 2. The vehicular charging inlet 10 is attached to a vehicle body surface 2a, e.g., a vehicle body side surface or a vehicle body front surface, of the vehicle 2. As shown in FIG. 1 and FIG. 3, the vehicular charging inlet 10 has a base 11, a cover 12, a connection port 13, and a marker 14.

The base 11 is a box member having a container shape or a box shape. The base 11 is attached and fixed in a state of being fitted to an attachment hole provided in the vehicle body surface 2a of the vehicle 2. The base 11 is a bottomed tubular member having a bottom wall portion formed on the back side, a side wall portion surrounding the peripheral edge of the bottom wall portion so as to form a storage space, and an opening formed on the front side. The base 11 is molded by resin or the like.

The cover 12 is a plate-shaped lid member for opening/closing the opening of the base 11. The cover 12 protects the inside of the storage space and therefore the connection port 13, from the outside of the vehicle body. The cover 12 is movable between a closed position where the opening of the base 11 is closed and an opened position where the opening is opened. Movement of the cover 12 may be such that, for example, the cover 12 rotates around a hinge shaft or the cover 12 moves along the vehicle body surface 2a.

Movement of the cover 12 from the closed position to the opened position may be performed by a predetermined charging start operation or a predetermined cover opening operation by a vehicle occupant or an operator, for example. Movement of the cover 12 from the closed position to the opened position may be performed such that the cover 12 is once moved from the closed position to an intermediate position (so-called half-opened position) between the closed position and the opened position by an elastic force of a spring or the like and then moved from the intermediate position to the opened position by hooking and position movement of an arm provided to the charging device 20, for example. Movement of the cover 12 from the opened position to the closed position may be performed by a predetermined charging finish operation or a predetermined cover closing operation by a vehicle occupant or an operator, for example. The cover 12 is supported such that the position thereof is movable relative to the base 11.

The connection port 13 is a connector at which a terminal provided at one end of a wire or a cable having another end connected to an in-vehicle battery is exposed. A connector portion 22a of the charging gun 22 described later of the charging device 20 is inserted into the connection port 13. The connection port 13 is stored in the storage space so as to be exposed from the bottom wall portion of the base 11 to the storage space. The in-vehicle battery is provided on the back side relative to the bottom wall portion of the base 11. At the closed position of the cover 12, the connection port 13 is hidden on the back side of the cover 12, and at the opened position of the cover 12, the connection port 13 is exposed to the outside of the vehicle through the opening of the base 11 so as to allow charging of the vehicle 2.

The marker 14 is an indication serving as a reference in performing positioning of the charging gun 22 relative to the connection port 13. The marker 14 is a light emitting member which emits light having a wavelength in a near-infrared region. The marker 14 is, for example, an LED light. Light having a wavelength in a near-infrared region is an electromagnetic wave having a wavelength of 0.75 μm to 1.5 μm, for example. Considering that sunlight tends to attenuate at wavelengths close to 820 nm, 860 nm, and 940 nm, the wavelength of light emitted by the marker 14 is preferably set to be close to these wavelengths.

The marker 14 may emit light having a wavelength in a near-infrared region along with a timing when the cover 12 is opened from the closed position or a timing when the cover 12 reaches the opened position, for example. The marker 14 may stop emitting light along with a timing when the cover 12 reaches the closed position from the opened position or a timing when the cover 12 is closed to such an extent that presence of the connection port 13 is not recognized from the outside of the vehicle.

The marker 14 is provided so as to be exposed to the outside of the vehicle body. Specifically, the marker 14 is attached to the bottom wall portion of the base 11. The marker 14 is formed so as to allow a control unit 27 described later of the charging device 20 to specify the position of the connection port 13 and the direction (hereinafter, referred to as an axial line direction) in which the axial line of the connection port 13 extends, at the time of inserting the connector portion 22a of the charging gun 22 into the connection port 13. The marker 14 is provided so as to emit light outward of the vehicle body, and may be attached in an exposed state at the front surface of the bottom wall portion of the base 11 so as to directly emit light or may be placed on the back side of the bottom wall portion of the base 11 so as to emit light through a transmissive material provided at the bottom wall portion.

The markers 14 are provided at least at three points of the base 11. Each of the “points” at which the markers 14 are provided is a point separate from the other “points” by predetermined distances or longer such that the relative position of the connection port 13 as seen from the charging device 20 side, the axial line direction of the connection port 13, and the angle position of the connection port 13 around the axial line are specified through processing of an image captured by a camera of the charging device 20. The markers 14 at three points may be formed of only point light sources present separately from each other at the three “points” or may be formed by a line-shaped light emitting body extending in a line shape including the three “points”, for example.

For example, as shown in FIG. 3, the markers 14 may be point light sources and may be provided at three different points. In this case, the markers 14 at three points may be arranged such that a shape formed by connecting the markers 14 at three points by lines becomes an equilateral triangle as seen along the axial line of the connection port 13 from the outside of the vehicle body.

For example, the markers 14 at two points, which are point light sources, are arranged separately from each other by a predetermined distance or longer (e.g., 30 mm or longer, 50 mm or longer, or 100 mm or longer) in a horizontal direction (e.g., a vehicle front-rear direction in a case where the vehicular charging inlet 10 is provided at a vehicle body side surface), and the marker 14 at the remaining one point, which is a point light source, is provided at a position above the vertical height positions of the markers 14 at the two points and separate from the markers 14 at the two points by equal distances (e.g., a distance of 30 mm or longer, 50 mm or longer, or 100 mm or longer) that are the same as the separation distance between the markers 14 at the two points. In this case, the markers 14 at three points may be arranged such that collection of points separate from the markers 14 at three points by equal distances becomes the axial line of the connection port 13.

As the markers 14, instead of point light sources arranged at three different points forming an equilateral triangle as described above, a line-shaped light emitting body may be provided along a V shape obtained by setting one of the three points as an intersection and connecting the one point with the remaining two points by lines. Instead of forming an equilateral triangle by three different points, the marker 14 may be arranged at three different points forming an isosceles triangle or four different points forming a square, as long as the shape is recorded on the charging device 20 side in advance.

The charging device 20 is a device for performing power feeding by supplying electric energy to the vehicle 2 in order to charge the vehicle 2. The charging device 20 is provided outside the vehicle 2, and for example, is provided at a charging station, a parking lot of a home or a shopping center, a rest area, a vehicle maintenance factory, or the like. The charging device 20 may be a stationary-stand type device installed and fixed on a ground, or may be a mobile-type device such as an AGV.

As shown in FIG. 1 and FIG. 2, the charging device 20 includes a stand body 21, the charging gun 22, a movement mechanism unit 23, an infrared camera 24, a visible light camera 25, an operation unit 26, and a control unit 27.

The stand body 21 is a stand at which the charging gun 22, the movement mechanism unit 23, the infrared camera 24, and the visible light camera 25 are provided. The stand body 21 is formed in a columnar shape or a prismatic shape. The stand body 21 includes a supply source storing electric energy, and a charger for outputting electric energy from the supply source. The charger may be adaptable to fast charging and may be adaptable to DC charging. The stand body 21 is installed and fixed on a ground or is provided to an AGV or the like.

The charging gun 22 is a member through which electric energy to be supplied to the vehicle 2 in charging of the vehicle 2 flows. The charging gun 22 is formed in a hose shape. The charging gun 22 is formed of a metal wire and a coating portion which coats the metal wire. One end of the charging gun 22 is connected to the supply source in the stand body 21. The charging gun 22 is flexible and bendable, and the position of another end, i.e., a distal end, of the charging gun 22 is freely movable relative to the stand body 21.

The charging gun 22 has the connector portion 22a. The connector portion 22a is provided at the other end of the charging gun 22. The connector portion 22a is inserted into the connection port 13 that the vehicular charging inlet 10 has. The connector portion 22a is configured in accordance with a predetermined standard such as Combined Charging System (CCS; see FIG. 3) or CHAdeMO. The charging gun 22 leads electric energy from the supply source to the in-vehicle battery side of the vehicle 2 through the connector portion 22a.

The movement mechanism unit 23 is a mechanism for moving the position of the charging gun 22. The movement mechanism unit 23 is configured to move the position of the connector portion 22a of the charging gun 22 to the connection port 13 of the vehicular charging inlet 10 of the vehicle 2, in a state in which the vehicle 2 is stopped in a predetermined area relative to the stand body 21 in advance. The movement mechanism unit 23 is configured to move the position of the connector portion 22a of the charging gun 22 in the front-rear direction, the left-right direction, and the up-down direction relative to the stand body 21, and rotate the connector portion 22a around an axial line thereof. The movement mechanism unit 23 is, for example, an articulated robot or a Cartesian coordinate robot, and has a structure that allows rotation at a wrist part.

The infrared camera 24 is a camera for detecting light having a wavelength in an infrared region (in particular, near-infrared region). The detection target wavelength of the infrared camera 24 is, for example, 0.75 μm to 1.5 μm. Specifically, considering that sunlight tends to attenuate at wavelengths close to 820 nm, 860 nm, and 940 nm, the detection target wavelength of the infrared camera 24 is preferably set to be close to these wavelengths.

The infrared camera 24 may have a light receiving element (e.g., indium gallium arsenide phosphide, InGaAsP) having sensitivity in a wavelength region including a near-infrared region, or may have a light receiving element (e.g., silicon photodiode, Si-PD) having sensitivity in a wavelength region including not only a visible light region but also a near-infrared region, and a filter for cutting off visible light, for example.

The infrared camera 24 is attached to the movement mechanism unit 23 or the stand body 21 of the charging device 20. For accurately specifying the positions of the markers 14, the infrared camera 24 is preferably attached at a position close to the connector portion 22a of the charging gun 22, e.g., at an arm distal end of the movement mechanism unit 23, for example.

The infrared camera 24 is configured to capture an image of the vehicular charging inlet 10 of the vehicle 2 stopped in a predetermined area relative to the stand body 21. In particular, the infrared camera 24 is configured to capture an image of an area including the markers 14 of the vehicular charging inlet 10 and an area around the connection port 13. The infrared camera 24 is used for specifying the positions of the markers 14 relative to the charging gun 22 of the charging device 20, and is used for detecting a foreign object that obstructs movement of the charging gun 22 at the time of insertion into the connection port 13. The foreign object is, for example, a towel, a plastic bag, or the like interposed between the base 11 and the cover 12 not present at the opened position or the cover 12 present at the opened position, or a person or the like that is present between the charging gun 22 and the connection port 13 and obstructs the connector portion 22a of the charging gun 22 from moving to the connection port 13.

The visible light camera 25 is a camera for detecting light having a wavelength in a visible light region. The visible light camera 25 is, for example, a CCD camera, and has a light receiving element (e.g., silicon photodiode, Si-PD) having sensitivity in a wavelength region including a visible light region. The visible light camera 25 is attached to the movement mechanism unit 23 or the stand body 21 of the charging device 20. The visible light camera 25 may be provided adjacently to the infrared camera 24.

The visible light camera 25 is configured to capture an image of the vehicular charging inlet 10 of the vehicle 2 stopped in a predetermined area relative to the stand body 21 in advance, and is, in particular, configured to capture an image of an area around the connection port 13. The visible light camera 25 is used for detecting a foreign object that obstructs movement of the charging gun 22 at the time of insertion into the connection port 13 or as a substitute when the infrared camera 24 has failed.

The operation unit 26 is a part including a panel on which an input operation is performed by a driver, a station worker, or the like for performing a charging start operation for the vehicle 2 or paying after charging is completed, a sensor for detecting the position of the vehicle 2, etc., and the like. The operation unit 26 is provided to the stand body 21, the charging gun 22, or the like. The operation unit 26 may include a portable device such as a smartphone that an occupant of the vehicle 2 carries, in addition to or instead of being provided to the stand body 21 or the charging gun 22.

Sequential charging processing from movement of the charging gun 22 by the movement mechanism unit 23 to supply of electric energy to the vehicle 2 and further payment processing, may be automatically started on a condition that a charging start operation is performed on the operation unit 26 by a person, or instead, a condition that the vehicle 2 is stopped in a predetermined area relative to the stand body 21 or the cover 12 of the vehicle 2 is opened, or a condition that a charging start operation or a payment operation is performed with an application in a smartphone, for example. Alternatively, the sequential charging processing may be completely automatically performed without any operation by a person.

The control unit 27 is a part for performing various controls for the charging device 20. The control unit 27 is mainly formed of a microcomputer. The control unit 27 is connected to the infrared camera 24, the visible light camera 25, and the operation unit 26, and is connected to an actuator that the movement mechanism unit 23 has. The control unit 27 starts charging processing (e.g., actuation of the infrared camera 24 and the visible light camera 25) in accordance with an input operation on the operation unit 26.

After the above charging processing is started, first, an infrared image captured by the infrared camera 24 and a visible light image captured by the visible light camera 25 are inputted to the control unit 27, and the control unit 27 processes the infrared image to specify the positions of the markers 14 of the vehicular charging inlet 10 of the vehicle 2, and processes the infrared image and the visible light image to determine whether or not there is a foreign object that obstructs movement of the charging gun 22. Then, if no foreign object is detected in an area around the connection port 13, the control unit 27 performs a driving instruction to the movement mechanism unit 23 so as to move the position of the charging gun 22 and insert the connector portion 22a into the connection port 13, in accordance with the positions of the markers 14.

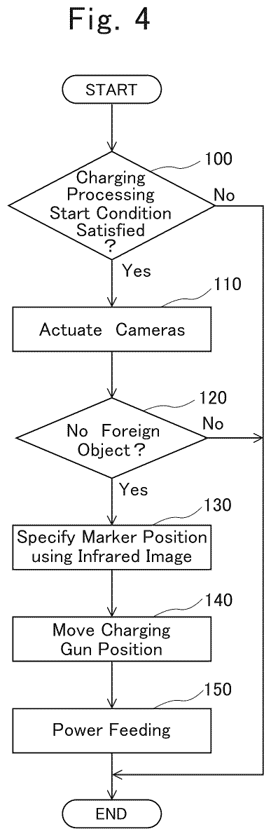

Next, with reference to FIG. 4, operation of the charging system 1 will be described.

When charging of the vehicle 2 is requested, the vehicle 2 is stopped in a predetermined area relative to the stand body 21 of the charging device 20. Then, after the vehicle 2 is stopped, if a marker light-up condition, e.g., the cover 12 is opened from the closed position or thereafter reaches the opened position, is satisfied, the markers 14 are lit up. In this case, light having a wavelength in a near-infrared region is emitted from the markers 14.

In the charging system 1, if the control unit 27 has determined that a charging start condition for charging the vehicle 2 is satisfied by an input operation on the operation unit 26 (in a case of positive determination in step 100 in FIG. 4), the control unit 27 causes the infrared camera 24 and the visible light camera 25 to start capturing (step 110). In this case, the infrared camera 24 and the visible light camera 25 capture images of the vehicular charging inlet 10 of the stopped vehicle 2 (specifically, an area including the markers 14 and an area around the connection port 13), and these images are processed by the control unit 27.

The control unit 27 determines whether or not there is a foreign object that obstructs movement of the charging gun 22 at the time of inserting the charging gun 22 into the connection port 13 of the vehicle 2, as a result of processing of each image (step 120). As a result, if the control unit 27 has determined that there is such a foreign object, the control unit 27 ends the present routine without proceeding through the process any more. In this case, the charging gun 22 is prohibited from moving to the connection port 13 of the vehicle 2 and charging of the vehicle 2 is not performed.

On the other hand, if the control unit 27 has determined that there is no such foreign object, next, the control unit 27 specifies the positions of the three markers 14 present in the infrared image captured by the infrared camera 24 (step 130). The control unit 27 performs positioning of the charging gun 22 relative to the connection port 13 on the basis of the specified positions of the three markers 14 in the infrared image. Specifically, the control unit 27 specifies the relative position of the connection port 13 as seen from the charging device 20 side, the axial line direction of the connection port 13, and the angle position of the connection port 13 around the axial line, and calculates a path through which the connector portion 22a is to move in order to insert the connector portion 22a of the charging gun 22 into the connection port 13.

The control unit 27 may record arrangement positions of the three markers 14 relative to the connection port 13 or a two-dimensional shape formed by the three markers 14, in advance, and may check the positions of the three markers 14 present in the infrared image with the recorded data, to calculate a movement path for the charging gun 22. The movement path may be such a path that the connector portion 22a of the charging gun 22 is first moved to a position on the axial line of the connection port 13 away from the connection port 13 and then is linearly moved along the axial line toward the connection port 13 so as to be inserted into the connection port 13.

After the movement path is calculated as described above, the control unit 27 drives the movement mechanism unit 23 so that the position of the charging gun 22 moves toward the connection port 13 in accordance with the positions of the markers 14. The movement mechanism unit 23 moves the position of the charging gun 22 toward the connection port 13 along the movement path in accordance with the driving instruction from the control unit 27 (step 140).

After insertion of the charging gun 22 into the connection port 13 is completed, next, the control unit 27 actuates the charger to perform power feeding for supplying electric energy to the vehicle 2 (step 150). When such power feeding is performed, electric energy flows through the charging gun 22, to charge the vehicle 2.

As described above, in the charging system 1, the vehicular charging inlet 10 provided to the vehicle 2 has the marker 14 serving as a reference in performing positioning of the charging gun 22 relative to the connection port 13 before insertion of the charging gun 22 into the connection port 13. In addition, the charging device 20 has the infrared camera 24 configured to capture an image of an area including the marker 14. Then, the movement mechanism unit 23 of the charging device 20 moves the position of the charging gun 22 toward the connection port 13 in accordance with the position of the marker 14 in the infrared image captured by the infrared camera 24.

In the charging system 1, the infrared camera 24 is used for specifying the position of the marker 14. With this configuration, an image obtained by the infrared camera 24 is less influenced by sunlight as compared to an image obtained by a general visible light camera, so that occurrence of underexposure in a dark place is suppressed and occurrence of overexposure (so-called blown-out highlights) due to direct sunlight or the like is suppressed. Thus, detection for the connection port 13 is stably performed and positioning accuracy for the charging gun 22 to the connection port 13 is stably ensured.

In particular, the infrared camera 24 detects light having a wavelength in a near-infrared region. Thus, with the charging system 1, the influence of sunlight is excluded, whereby detection for the connection port 13 is stably performed and positioning accuracy for the charging gun 22 to the connection port 13 is improved.

In the charging system 1, the marker 14 is a light emitting member which emits light having a wavelength in a near-infrared region. Thus, the position of the marker 14 is accurately specified using the infrared camera 24, whereby detection accuracy for the connection port 13 is improved and therefore positioning accuracy for the charging gun 22 to the connection port 13 is improved. When the marker 14 is lit up, light having a wavelength in a near-infrared region from the marker 14 is not perceived by human eyes. Thus, occurrence of such a situation that the design of the vehicular charging inlet 10 is deteriorated by lighting up of the marker 14 is avoided.

The markers 14 are provided at least at three points. Thus, the relative position of the connection port 13 as seen from the charging device 20 side, the axial line direction of the connection port 13, and the angle position of the connection port 13 around the axial line are specified, whereby positioning accuracy for the charging gun 22 to the connection port 13 is improved.

In the charging system 1, the charging device 20 has the visible light camera 25 configured to capture an area around the connection port 13, separately from the infrared camera 24. Then, through processing of a visible light image captured by the visible light camera 25, a foreign object that obstructs movement of the charging gun 22 at the time of inserting the charging gun 22 into the connection port 13 is detected. In a case where a foreign object is detected, movement of the charging gun 22 is prohibited, and in a case where there is no foreign object, the position of the charging gun 22 is moved toward the connection port 13 so that the charging gun 22 is inserted into the connection port 13. Thus, safety in moving the position of the charging gun 22 toward the connection port 13 is ensured.

In particular, also when the infrared camera 24 has failed, a foreign object in an area around the connection port 13 is detected on the basis of a visible light image, and this allows position movement of the charging gun 22 to the connection port 13 to be performed while ensuring safety of the position movement.

The infrared camera 24 is also used for detecting a foreign object that obstructs movement of the charging gun 22 at the time of inserting the charging gun 22 into the connection port 13. That is, through processing of an infrared image captured by the infrared camera 24, a foreign object that obstructs movement of the charging gun 22 at the time of inserting the charging gun 22 into the connection port 13 is detected. With this configuration, also in performing foreign object detection around the connection port 13, the influence of sunlight is excluded, whereby accuracy of foreign object detection is improved and safety of position movement of the charging gun 22 toward the connection port 13 is improved.

Here, in the above embodiment, the marker 14 serving as a reference in performing positioning of the charging gun 22 relative to the connection port 13 before insertion of the charging gun 22 into the connection port 13 is a light emitting member which emits light having a wavelength in a near-infrared region. However, the present disclosure is not limited thereto, and the marker 14 may not emit light having a wavelength in a near-infrared region. In this case, for example, the marker 14 may be formed from a material that readily reflects light having a wavelength in a near-infrared region, and an infrared lighting unit for emitting light having a wavelength in a near-infrared region toward an area including the marker 14 may be provided at the base 11 of the vehicular charging inlet 10 or a distal end of the charging gun 22 of the charging device 20.

In the above embodiment, a foreign object that obstructs movement of the charging gun 22 at the time of inserting the charging gun 22 into the connection port 13 is detected using both of the visible light camera 25 and the infrared camera 24. However, the present disclosure is not limited thereto, and a foreign object that obstructs movement of the charging gun 22 at the time of inserting the charging gun 22 into the connection port 13 may be detected using only the visible light camera 25.

The present disclosure is not limited to the embodiments and the modifications described above, and various changes may be made without departing from the gist of the present disclosure. The description discloses not only technical features shown by the reference relationship described in the claims at the time of filing of the present application but also technical features obtained by combining matters described in the claims as appropriate.

This application claims priority on Japanese Patent Application No. 2023-166422 filed in Japan on Sep. 27, 2023, the entire contents of which are incorporated herein by reference.

1. A charging system comprising:
a vehicular charging inlet provided to a vehicle and having a connection port exposable to outside of a vehicle body; and
a charging device provided outside the vehicle and including a charging gun having a connector portion to be inserted into the connection port at a time of charging the vehicle, and a movement mechanism unit configured to move a position of the charging gun, wherein
the vehicular charging inlet has a marker provided so as to be exposed to outside of the vehicle body and serving as a reference in performing positioning of the charging gun relative to the connection port before insertion of the charging gun into the connection port,
the charging device includes an infrared camera configured to capture an image of an area including the marker, and
the movement mechanism unit moves the position of the charging gun toward the connection port in accordance with a position of the marker in the image captured by the infrared camera.

2. The charging system according to claim 1, wherein
the infrared camera detects light having a wavelength in a near-infrared region.

3. The charging system according to claim 2, wherein
the marker is a light emitting member which emits the light having the wavelength in the near-infrared region.

4. The charging system according to claim 1, wherein
the markers are provided at least at three points.

5. The charging system according to claim 1, wherein
the charging device includes a visible light camera configured to capture an area around the connection port, for detecting a foreign object that obstructs movement of the charging gun at a time of inserting the charging gun into the connection port or as a substitute when the infrared camera has failed.

6. A vehicular charging inlet comprising:
a connection port which is exposable to outside of a vehicle body and into which a charging gun of a charging device provided outside a vehicle is inserted at a time of charging the vehicle; and
a marker which is provided so as to be exposed to outside of the vehicle body and whose image is to be captured by an infrared camera attached to the charging gun before insertion of the charging gun into the connection port, the marker serving as a reference in performing positioning of the charging gun relative to the connection port, for position movement of the charging gun by a movement mechanism unit of the charging device.

7. A charging device comprising:
a charging gun to be inserted into a connection port of a vehicular charging inlet provided to a vehicle, at a time of charging the vehicle;
an infrared camera configured to capture an image including a marker which is provided to the vehicular charging inlet so as to be exposed to outside of a vehicle body; and
a movement mechanism unit configured to move a position of the charging gun toward the connection port in accordance with a position of the marker in the image captured by the infrared camera.

8. A charging method for charging a vehicle by inserting a charging gun of a charging device provided outside the vehicle into a connection port of a vehicular charging inlet provided to the vehicle, the charging method comprising:
a first step of, by an infrared camera of the charging device, capturing an image of an area including a marker which is provided to the vehicular charging inlet so as to be exposed to outside of a vehicle body; and
a second step of, by a movement mechanism unit of the charging device, moving a position of the charging gun toward the connection port in accordance with a position of the marker in the image captured by the infrared camera.
